(19) United States
(12) Patent Application Publication
(10) Pub. No.: US 2025/0020122 A1
(43) Pub. Date: Jan. 16, 2025

(54) DEVICE AND METHOD FOR CONTROLLING OPERATIONAL VIBRATIONS OF A PUMP OR PUMP ASSEMBLY

(71) Applicant: GRUNDFOS HOLDING A/S, Bjerringbro (DK)

(72) Inventors: Lasse Søgaard LEDET, Bjerringbro (DK); Jan Balle LARSEN, Bjerringbro (DK)

(21) Appl. No.: 18/688,104

(22) PCT Filed: Sep. 14, 2022
(86) PCT No.: PCT/EP2022/075548

§ 371 Date: Feb. 29, 2024

(30) Foreign Application Priority Data
Sep. 17, 2021 (DK) PA 2021 00887

(51) Int. Cl. F04B 53/00; F04B 49/06

(52) U.S. Cl. CPC F04B 53/003; F04B 49/065

(57) ABSTRACT

The invention is a device (1) for controlling operational vibrations of a pump (2) or pump assembly arranged thereon. In some embodiments, it comprises a mounting plate (3) configured to have the pump or pump assembly arranged on a surface thereof. The device comprises at least one actuator (6) configured to switch between a first state in which it provides a connection between the pump or pump assembly and an associated carrying surface or between the mounting plate and the carrying surface, and a second state in which there is no such connection via the at least one actuator. Activation of the at least one actuator to switch between the first and the second states is controllable so that resonance characteristics of the pump or pump assembly during operation can be changed by the activation.

### FIELD OF THE INVENTION

The present invention relates to a device and a method for controlling operational vibrations of a pump or pump assembly. In particular, it relates to such a device and method which is configurable for use with different types and/or sizes of pumps or pump assemblies.

### BACKGROUND OF THE INVENTION

Trends within rotating machinery, specifically centrifugal pumps, move towards E-products to accommodate variable and high-speed pumps in order to improve efficiencies, reduce the number of variants, boost during peak hours etc. One of the main challenges with variable speed pumps is that they operate in a wide speed range where eigenfrequencies, also known as resonances, will inevitably be present. Operation of the pump in and around resonances gives rise to operational vibrations that pose severe challenges and compromise the integrity of the pump itself, e.g. due to wear and fatigue, as well as the system and building in which it is operating. In addition, the vibrations also cause noise that is normally undesirable for the surroundings.

In order to cope with the operational vibrations propagating to the floor on which a pump is placed and further into the building, pumps are typically mounted on so-called inertia bases. Inertia bases consist of heavy concrete blocks and soft springs to lower the overall resonance of the system. However, this is an expensive and sometimes impractical solution in terms of commissioning. Furthermore, even though it reduces the transmission of the operational vibrations to the surroundings, it does not necessarily ensure low vibration levels and long lifetime of the pump itself.

Other attempts to try limiting or avoiding vibrational fatigue of the pump, propagation of the vibrations to the surroundings, and severe noise levels are methods aiming at controlling these resonances either by damping or by other passive solutions. However, damping and other passive solutions are not always sufficient to accommodate the typical challenges, since pumps operate differently. The same pump may run at different speeds or flow points and therefore this can change how far it is from the resonances. Furthermore, a given pump is typically a part of vastly different systems in which the pump fixation, also known as the boundary conditions, can vary greatly. These are important factors that essentially determine the modes and frequencies of the resonances. Moreover, the specific operation of a pump, e.g. with respect to the rotations per minute (RPM), is controlled by the user-demands, and therefore adjusting the RPM to circumvent resonances is typically not an optimal solution.

Thus, an improved device and method for controlling operational vibrations of a pump or pump assembly would be advantageous.

### OBJECT OF THE INVENTION

It is an object of the present invention to provide a device for controlling operational vibrations of a pump or pump assembly which device is configurable for different applications, such as for different types and sizes of pumps or pump assemblies.

It is an object of at least some embodiments of the present invention to provide a device for controlling operational vibrations of a pump or pump assembly which device is easier to adapt to a given application than known devices.

It is another object of at least some embodiments of the present invention to provide a device for controlling operational vibrations of a pump or pump assembly with which a more efficient and precise control can be obtained than with known devices.

It is a further object of the present invention to provide an alternative to the prior art.

In particular, it may be seen as an object of the present invention to provide a device and method for controlling operational vibrations of a pump or pump assembly that solves the above mentioned problems of the prior art.

### SUMMARY OF THE INVENTION

Thus, the above-described object and several other objects are intended to be obtained in a first aspect of the invention by providing a device for controlling operational vibrations of a pump or pump assembly arranged thereon, the device comprising:
at least one actuator configured to switch between:
   a first state in which the actuator provides a connection between the pump or pump assembly and an associated carrying surface, and
   a second state in which there is no connection between the pump or pump assembly and the associated carrying surface via the at least one actuator,
wherein activation of the at least one actuator to switch between the first and the second states is controllable so that resonance characteristics of the pump or pump assembly during operation can be changed by the activation.

In relation to the statement that the pump or pump assembly is arranged on the device, the use of the term “thereon” does not necessarily mean “on top of”. The carrying surface can e.g. be the floor or wall at the site of installation or a surface of a separate carrying plate mounted on the floor or wall. Correspondingly, the pump and pump assembly may also be arranged sideways on a wall; this is also covered by the scope of protection. This will be explained in further details in the following.

The device may further comprise at least one support configured to be arranged between the pump or pump assembly and the carrying surface to provide a distance there between, the at least one support being configured to carry the weight of the pump or pump assembly.

In such embodiments as just mentioned, the device may further comprise a mounting plate configured to have the pump or pump assembly arranged on a surface thereof,
wherein the at least one support is arranged between the mounting plate and the carrying surface to provide a distance there between, the at least one support being configured to carry the weight of the mounting plate and the pump or pump assembly, and
wherein in the first state the actuator provides a connection between the mounting plate and the carrying surface, and in the second state there is no connection between the mounting plate and the carrying surface via the at least one actuator.

Thus, in an alternative formulation covering the embodiments as just described, the above-described object and several other objects are intended to be obtained in an alternative first aspect of the invention by providing a device for controlling operational vibrations of a pump or pump assembly arranged thereon, the device comprising:
a mounting plate configured to have the pump or pump assembly arranged on a surface thereof,
at least one support arranged between the mounting plate and a carrying surface to provide a distance there between, the at least one support being configured to carry the weight of the mounting plate and the pump or pump assembly,
at least one actuator configured to switch between:
   a first state in which the actuator provides a connection between the mounting plate and the carrying surface, and
   a second state in which there is no connection between the mounting plate and the carrying surface via the at least one actuator,
wherein activation of the at least one actuator to switch between the first and the second states is controllable so that resonance characteristics of the pump or pump assembly during operation can be changed by the activation.

By “operational vibrations” is meant vibrations that occur during use of the pump or pump assembly, typically due to the rotational movement of the rotor of the motor powering the pump. The aim of changing the resonance characteristics is typically to avoid critical operational values without having to change the operation point of the pump or at least to change to values resulting in acceptable levels of vibrations.

By “pump assembly” is meant the assembly of a pump and other components co-operating therewith, such as pipes attached to the pump or an assembly of a plurality of pumps mounted on a joint frame.

In embodiments comprising a mounting plate, the pump or pump assembly is typically arranged on an upper surface of the mounting plate. However, the scope of protection also covers other embodiments, such as having it arranged on a sidewall of a carrying element comprising the mounting plate. The at least one actuator can be mounted in different ways, and some examples will be shown in the figures. It may e.g. be mounted, directly or via another mounting element, on the mounting plate or on the carrying surface. In embodiments having more than one actuator, they may all be mounted in the same manner or differently, such as having some mounted on the mounting plate and some mounted on the carrying surface. Thus, the at least one actuator is preferably arranged between the mounting plate and the carrying surface. It could also be mounted differently, such as on top of the mounting plate and through a through-going hole therein get in contact with the carrying surface.

The connection which is established in the first state between the pump or pump assembly and the carrying surface or between the mounting plate and the carrying surface via the actuator may be a physical connection, but when an electromagnet is used as an actuator, the connection may also include a physical gap. A connection comprising a gap could therefore be referred to as a virtual connection. Thus, in the present context, “connection” means that it provides stiffness to the device so that the resonance characteristics is thereby influenced. The stiffness provided may be either negative or positive depending on the desired way of controlling the resonance characteristics. The provision of a connection typically results in nodes of no or substantially no movement, but for some types of actuators, the connection may be elastic so that some but less movement than without the connection is allowed.

By “controllable” is meant that the activation can be done in dependence of the actual resonance characteristics of the pump or pump assembly. Such characteristics may be known beforehand, such as from computer simulations and/or experiments, or they may be found by monitoring during operation e.g. by use of vibration sensors. The resonance characteristics may e.g. be determined by the frequencies of the fundamental resonance of the pump or pump assembly. However, any type of related parameter that is found relevant for a given application is covered by the scope of protection.

By “actuator” is meant any component which is configured to switch between a first state and a second state in a controllable manner and which by activation can ensure that resonance characteristics of the pump or pump assembly during operation can be changed. Examples of such actuators will be given below. The act of activating the actuator will depend on the type of actuator used. It may e.g. be to supply current, heat, or a pressure or flow of fluid to the actuator.

When the actuator is in the second state, the weight of the mounting plate, when present, and the pump or pump assembly is carried by the at least one support. When the actuator is in the first state, at least a part of this weight may be carried by the at least one actuator.

In summary, a device according to the invention can be used to provide noise and vibration control of a pump or pump assembly by manipulating the resonances of the pump or pump assembly in a way such that it is possible to move or change the resonances away from critical operational regimes, e.g. with respect to the RPM, without changing the operation point of the pump or pump assembly. The overall idea on which the invention is based is the principle of being able to change the stiffness of the device on which the pump or pump assembly is mounted so that the frequencies of the fundamental resonances will change to such an extent that the noise and vibration levels decrease to an acceptable level.

In some embodiments of the invention, the connection between the pump or pump assembly and the carrying surface, or between the mounting plate and the carrying surface, respectively, when the at least one actuator is in the first state is a physical connection. At least for some configurations, this will result in a larger stiffness of the device.

The location of the at least one actuator with respect to the pump or pump assembly or with respect to a plane of extension of the mounting plate, when present, may be adjustable. Hereby it is obtained that one set of mounting plate, when present, and at least one actuator is configured so that it can be adjusted to match a given application, such as a given specific type and size of pump or pump assembly. Hereby it is obtained that one device can be used for different applications by adjusting the device itself accordingly via built-in features.

The at least one actuator may be a linear or a rotational actuator.

The at least one actuator may be selected from the group consisting of: wax motor, solenoid, bellow, thermal actuator, electric actuator, hydraulic actuator, pneumatic actuator, or a combination thereof.

In some embodiments of the invention, the at least one actuator is a self-locking actuator. The self-locking feature may e.g. be obtained via a spindle that remains in a given position without the need for continued supply of power. An advantage thereof is that when the actuator is set to a desired state, the power can be turned off until a change of state is needed.

The at least one actuator may be at least one electromagnet. Hereby the stiffness of the device and thereby the resonance characteristics can be varied in dependence of one or more of the following variables: the number of windings, the supplied current, the area, the magnetic constant, and the distance between the actuator and the plate with which it interacts. Such at least one electromagnet may also be used in combination with one or more of the other types of actuators mentioned above. Embodiments based on the use of one or more electromagnets require that the counter plate or regions thereof comprises material that can interact with the electromagnet. By “counter plate” is meant the plate which the electromagnet is to interact with to provide the connection in the first state. It therefore depends on how the electromagnet is mounted, but it could e.g. be the mounting plate, when present.

The activation of an actuator may be performed by turning the at least one actuator on and off. When the actuator is an electromagnet, the strength of the electromagnet may be variable by changing the amount of the electric current supplied to the electromagnet. This may e.g. be done to adjust it for use with pumps or pump assemblies of different size and/or weight. A variable strength of the electromagnet may also be used as part of the control used for changing the resonance characteristics of the pump or pump assembly. The strength of the actuator may also be variable for at least some of the other types of actuators mentioned.

In some embodiments of the invention comprising a support, the at least one support is provided as foam material, such as polymer foam. Such foam material can e.g. be used to provide the support over a large area. The at least one actuator may be embedded in the foam as will be shown in the figures. Alternatives are e.g. bolts or fixed elements, such as rods or brackets. The mounting plate, when present, may bend or may move without bending dependent on the type of support used.

The at least one support may be adjustable to change the distance between the pump or pump assembly and the carrying surface or between the mounting plate and the carrying surface, respectively, and thereby typically also the distance between the actuator and the plate with which it interacts, such as the mounting plate or the carrying plate. Hereby the device can be designed for use with a larger range of pumps or pump assemblies. The adjustability may include replacing a given set of support with another one. This may typically be the solution when the support is provided by foam material. Whether or not such adjustability of the distance is needed also depends on the type and size of the actual at least one actuator used. For some actuators and some applications, the stroke of the at least one actuator may be a sufficient size to fulfil the actual requirements.

The device may comprise a plurality of individually controllable actuators whereby a high degree of adjustability and thereby control can be obtained. However, for some applications it will be sufficient to control the settings of all the actuators together.

The device may be configured to monitor the resonance characteristics of the pump or pump assembly during operation and to use the output of the monitoring to adjust the settings of the device when necessary to ensure that vibrational requirements are fulfilled.

In a second aspect, the invention relates to a method of controlling operational vibrations of a pump or pump assembly, the method comprising the following steps:
arranging a device according to the first aspect of the invention at a location of installation of the pump or pump assembly,
setting the device to control the operational vibrations of the pump or pump assembly while taking into account resonance characteristics of the pump or pump assembly, and
operating the pump or pump assembly.

In embodiments wherein the device comprises a mounting plate as described above, the method may further comprise a step of arranging the pump or pump assembly on the mounting plate.

For some embodiments of the invention, the resonance characteristics of the pump or pump assembly have been predetermined by computer simulations and/or tests performed on the pump or pump assembly or a computer model thereof.

In embodiments wherein the device is configured so that the location of the at least one actuator with respect to the pump or pump assembly or with respect to a plane of extension of the mounting plate, when present, is adjustable, the step of setting the device may comprise setting the location of the at least one actuator in accordance with the specific pump or pump assembly.

In embodiments wherein the device is configured so that the at least one support is adjustable, the step of setting the device may comprise setting the distance between the pump or pump assembly and the carrying surface or between the mounting plate and the carrying surface in accordance with the specific pump or pump assembly.

A method according to the invention may further comprise monitoring the resonance characteristics of the pump or pump assembly during operation and using the output of the monitoring to automatically adjust settings of the device when necessary to ensure that vibrational requirements remain fulfilled. Such monitoring may comprise the use of one or more of the following types of sensor inputs: accelerometer, vibration velocity, microphone/MEMS, motor current from the pump, RPM of the pump. The electromagnet itself could also form or comprise the sensor. The control signals from these sensors can e.g. be standard root-mean-square, peak-to-peak signals, or advanced envelope techniques. The sensors may e.g. be positioned on the device itself or on the pump or pump assembly. Which settings to adjust and how this is performed depend on the type of actuator used.

The first and second aspects of the present invention may be combined. These and other aspects of the invention will be apparent from and elucidated with reference to the embodiments described hereinafter.

### BRIEF DESCRIPTION OF THE FIGURES

The device and method for controlling operational vibrations of a pump or pump assembly according to the invention will now be described in more detail with regard to the accompanying figures. The figures show one way of implementing the present invention and is not to be construed as being limiting to other possible embodiments falling within the scope of the attached claim set.

FIG. 1 schematically shows a device according to an embodiment of the invention and having a pump arranged thereon.

FIG. 2 schematically shows an embodiment of the invention comprising two linear actuators. FIG. 2.a shows the actuators being in the first state, and FIG. 2.b shows the actuators being in the second state.

FIG. 3 schematically shows another embodiment of the invention comprising one electromagnet as the only actuator. FIG. 3.a shows the actuator being in the first state, and FIG. 3.b shows the actuator being in the second state.

FIGS. 4.a and 4.b schematically show two other embodiments comprising an electromagnet.

FIG. 5 schematically shows how a device according to the invention can be used to change the resonance characteristics of the pump or pump assembly by adding or removing stiffness by activating the at least one actuator.

FIG. 6 schematically shows different ways of arranging an electromagnet.

FIGS. 7 and 8 schematically show two other embodiments of the invention.

FIG. 9 schematically shows the device of FIG. 1 before arrangement of the pump thereon. FIGS. 9.a and 9.b show the device without and with the mounting plate, respectively.

FIG. 10 is a flow-chart of an embodiment of a method according to the invention.

FIGS. 11.a and 11.b schematically show two embodiments in which the device does not comprise a mounting plate.

### DETAILED DESCRIPTION OF AN EMBODIMENT

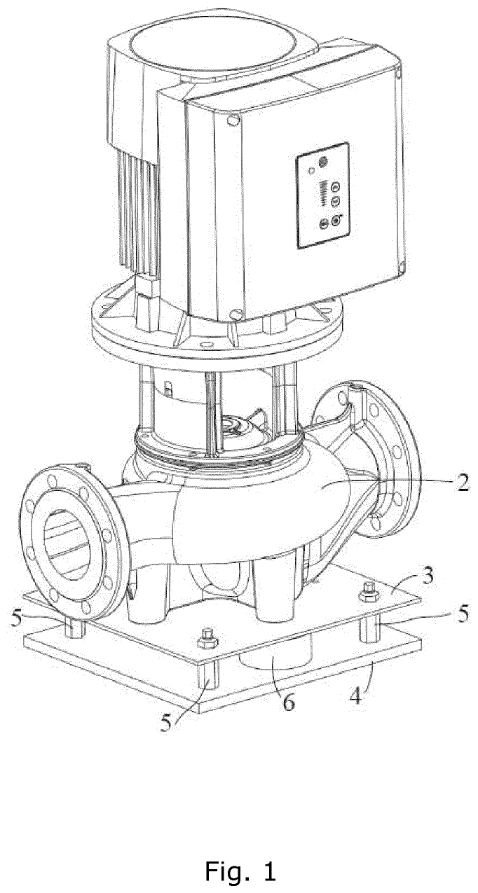

FIG. 1 schematically shows an embodiment of the invention after installation, i.e. with the device 1 having a pump 2 arranged thereon so that the device 1 is ready to be used for controlling operational vibrations of the pump 2. One pump is shown, but the scope of protection also covers pump assemblies as described in details above. For such embodiments, the same description as in the following applies.

The device 1 in FIG. 1 comprises a mounting plate 3 having the pump 2 arranged on a surface thereof. The embodiment has a carrying plate 4 which is mounted to the floor. Supports 5 are arranged between the mounting plate 3 and the carrying plate 4 to provide a distance there between. In FIG. 1, the supports 5 are shown as rods threaded at one end and having a fixed length, but any type of element providing the required support is meant to be covered. It could e.g. be bolts so that the length thereof and thereby the distance between the mounting plate 3 and the carrying plate 4 is adjustable. Alternatively or in combination therewith, replaceable spacers 5 can be used to adjust the distance in accordance with a given set-up. The number of supports 5 in FIG. 1 is four, one at each corner, but any suitable number is possible and will depend e.g. on the size of the parts. Typically, there should be at least three and preferably more supports 5 to ensure a stable design. In most of the figures, the pump 2 is not shown, but during use, it will typically be arranged on top of the mounting plate 3.

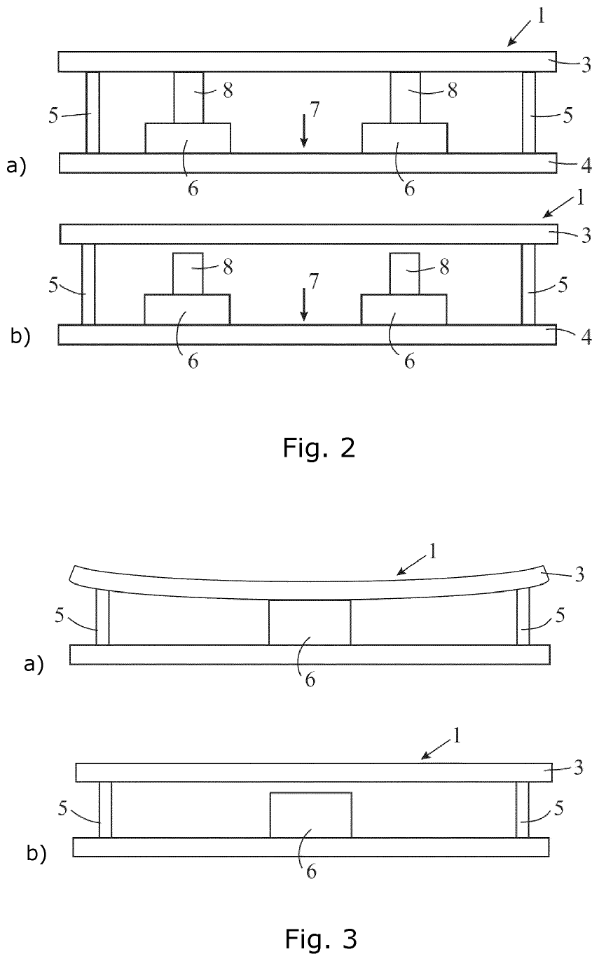

FIG. 2 schematically shows an embodiment of the invention comprising two linear actuators 6 which are configured to switch between a first state as shown in FIG. 2.a and a second state as shown in FIG. 2.b. In the first state, the actuators 6 provide a physical connection between the mounting plate 3 and a carrying surface 7, and in the second state there is no connection between the mounting plate 3 and the carrying surface 7 via the actuators 6. In the embodiment in FIG. 2, the carrying surface 7 is the upper surface of the carrying plate 4, but as mentioned above, it could alternatively be the floor. As is seen from FIG. 2.b, the supports 5 should be configured to carry the weight of the mounting plate 3 and the pump (see FIG. 1) when the actuators 6 are in the second state, where there is no connection via the actuators 6. When the actuators 6 are in the first state, a part of the weight is typically carried by the actuators 6. The actuators 6 can be activated to switch between the first and the second states. Hereby the device 1 is controllable so that resonance characteristics of the pump 2 during operation can be changed by the activation of the actuators 6.

The embodiment in FIG. 2 has actuators 6 with a variable length of e.g. an actuator piston 8. However, the device 1 could also comprise at least one actuator 6 which is selected from the group consisting of: wax motor, solenoid, bellow, thermal actuator, electric actuator, hydraulic actuator, pneumatic actuator, or a combination thereof. FIG. 3 schematically shows an alternative embodiment using an electromagnet as actuator 6. Only one electromagnet 6 is shown in this figure, but there could also be other numbers. FIG. 3.a shows the first state in which electric current is being supplied so that the electromagnet 6 is active and attracts the magnetic mounting plate 3, and FIG. 3.b shows the second state without attraction. The whole of the mounting plate 3 does not need to be magnetic. The same effect could be obtained by fastening magnetic material on a non-magnetic mounting plate 3 at regions facing the electromagnet 6. The mounting plate 3 is schematically shown as being mounted on rigid supports 5 arranged near the edges of the mounting plate 3 so that in the second state, the mounting plate 3 deflects downwards due to the interaction with the electromagnet 6. In embodiments comprising at least one electromagnet, the activation thereof can be performed by turning the at least one electromagnet on and off. Furthermore, the strength of the electromagnet can be variable whereby it will be possible to adjust the device for use with different types and sizes of pumps.

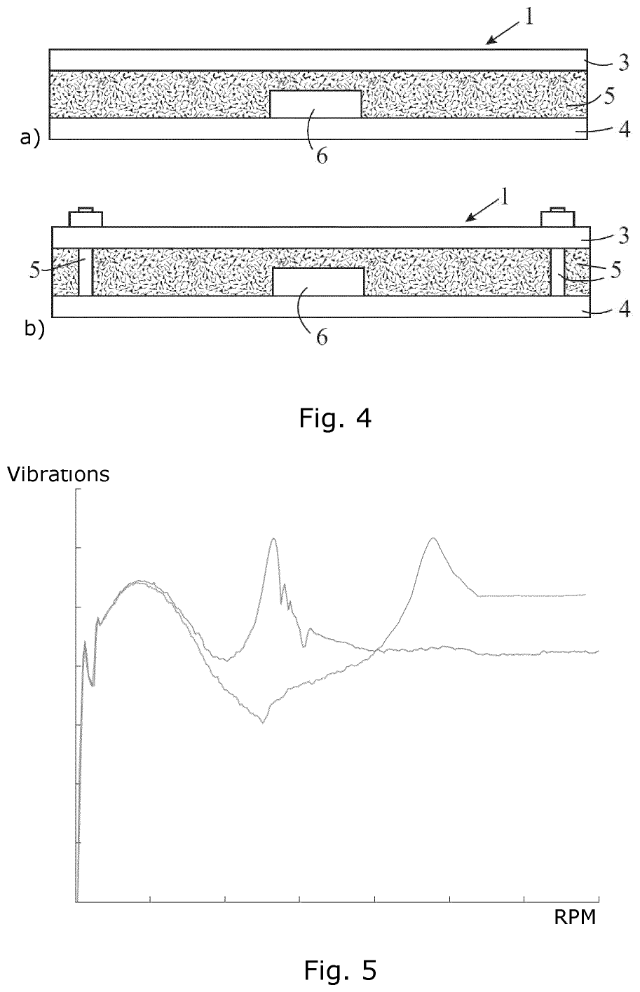

A device 1 resembling the one in FIG. 3 but having another type of support 5 is schematically shown in FIG. 4.a. Here the support 5 between the carrying plate 4 and the mounting plate 3 is in the form of a foam material 5 which is configured to carry the mounting plate 3 and the pump 2 when the electromagnetic actuator 6 is in the second state. Furthermore, the foam material is elastically deformable under the action of the attractive forces between mounting plate 3 and the electromagnet 6 in the first state. Such a foam material may e.g. be made from a polymer foam. If desired, it will be possible to combine different types of supports 5, such as shown in FIG. 4.b which is a combination of the supports 5 in FIGS. 3 and 4.a.

FIG. 5 schematically shows how a device 1 according to the invention can be used to change the resonance characteristics of a pump 2 or pump assembly arranged thereon by activating the at least one actuator 6 in order to add or remove stiffness. The figure shows the results of tests made with a device 1 using electromagnets as actuators 6. The left curve shows the vibrations as a function of the rotational speed of the pump 2 with the actuators 6 in the second state, and the right curve shows the vibrations for the same system but with the actuators 6 switched to the first state. By “left curve” and “right curve” is meant the curve with the top to the left and to the right, respectively. As seen from the figure, a device 1 according to the invention can be used to temporarily move the resonances away from critical operational regimes without changing the operation point of the pump 2.

The arrangement of the actuators 6 is important and is essentially to be determined by the mode shapes of the pump 2 and device 1. In relation to mode shapes, an essential parameter to use in the design is the location of nodes where the movement is zero, often a rotational axis or a point of rotation, and anti-nodes where the movement is a local maximum. The mode shapes and thereby nodes and anti-nodes are different for each resonance. As an example: If the actuators 6 are placed under nodes, there will be no change of that resonance no matter the added stiffness due to the actuators 6, since there is no movement to provide a reactive force. Therefore, to provide the intended control of the operational vibrations, it is important to understand the mode shapes of the device 1 and the pump 2, so that the actuators 6 can be placed near anti-nodes. The best position is not always at the anti-nodes as it depends on the device 1, the pump 2, and the interface between the pump 2 and the device 1. As the mode shapes are different for each resonance, the controlling of several resonances at once requires either multiple actuators or a compromise between nodes and anti-nodes of the resonances.

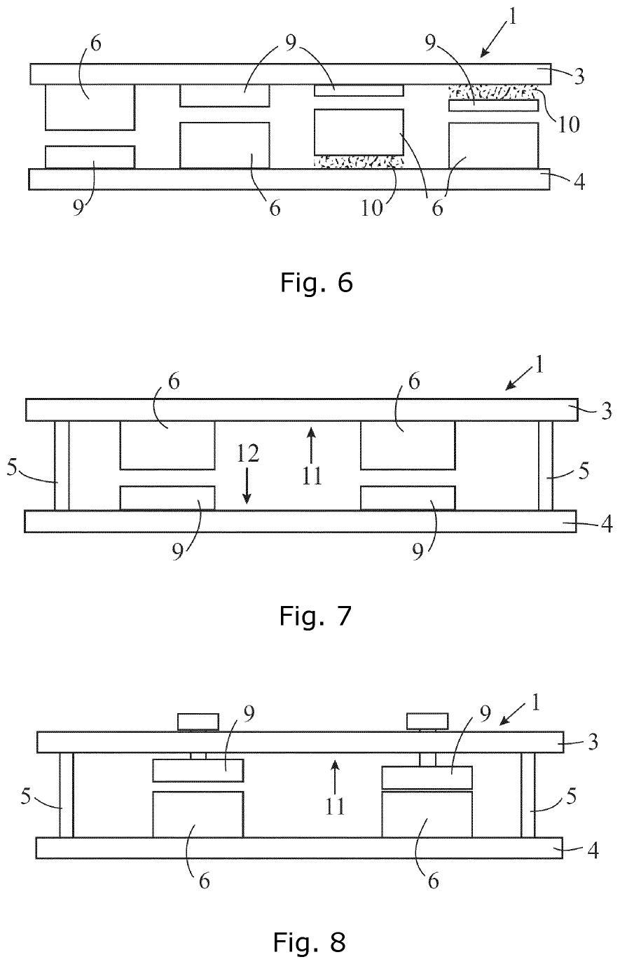

FIG. 6 schematically shows examples of possible arrangements of an electromagnet 6, a counter plate in the form of a magnetic element 9 to be fastened to one of the plates 3,4, and a spacer 10 for adjustment of the distance between the electromagnet 6 and the plate 3,4 or magnetic element 9 with which it is to counteract so that a desired functioning can be ensured for a given application. In FIG. 6, the supports are not shown. A spacer can also be used to specifically control the stiffness even in embodiments where the electromagnet is in physical contact with the plate 3,4 or magnetic element 9 in the first state. If the spacer is a spring of e.g. 100 N/m spring coefficient, then exactly that added stiffness will be obtained when clamping.

An advantage of the present invention is that it can be designed so that it is configurable for use with different types and sizes of pumps. This can be enabled by designing the device so that the location of the at least one actuator 6 with respect to a plane of extension of the mounting plate 3 is adjustable. It can e.g. be obtained by providing the mounting plate 3 and/or the carrying plate 4 with a plurality of mounting holes or brackets for fastening of the at least one actuator 6. Alternatively or in combination therewith, the device 1 may comprise a plurality of individually controllable actuators 6. Hereby it will be possible to activate only some of the actuators 6 or to control them to be active at different times, e.g. dependent on the actual operational vibrations of the pump 2.

FIG. 7 schematically shows another embodiment of the invention. It comprises two actuators 6 in the form of electromagnets arranged on the lower surface 11 of the mounting plate 3 and two magnetic elements 9 arranged on the upper surface 12 of the carrying plate 4. In this embodiment, the upper surface 12 of the carrying plate 4 corresponds to the carrying surface 7 shown in FIG. 2.

FIG. 8 schematically shows another embodiment of the invention. It comprises two actuators 6 in the form of electromagnets arranged on the upper surface 12 of the carrying plate 4 and two magnetic elements 9 arranged on the lower surface 11 of the mounting plate 3. As shown in the figure, these magnetic elements 9 may be adjustable.

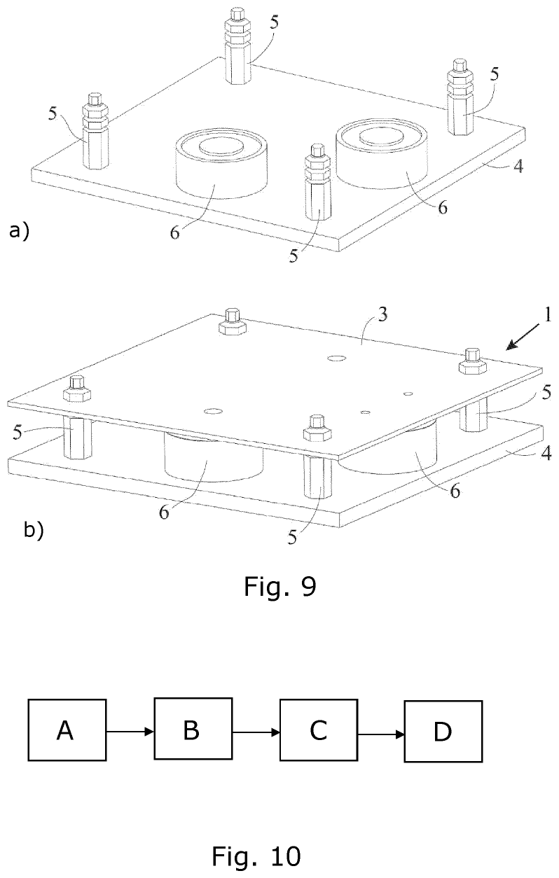

FIG. 9 schematically shows the device 1 of FIG. 1 before arrangement of the pump 2 thereon. FIGS. 9.a and 9.b show the device 1 without and with the mounting plate 3, respectively. The device 1 comprises two actuators 6 in the form of electromagnets mounted on the carrying plate 4 and four supports 5 arranged near the corners of the carrying and mounting plates 3,4.

FIG. 10 is a flow diagram of a method according to the second aspect of the invention when the device comprises a mounting plate as described above. The method comprises the following steps:
A: Arranging a device 1 according to any of the preceding claims at a location of installation of the pump 2 or pump assembly,
B: arranging the pump 2 or pump assembly on the mounting plate 3,
C: setting the device 1 to control the operational vibrations of the pump 2 or pump assembly while taking into account resonance characteristics of the pump 2 or pump assembly, and
D: operating the pump 2 or pump assembly.

Depending on the specific design of the device 1, a method may comprise further steps to take advantage of the optional features described above, such as adjusting the location of the actuators 6 or the distance between the carrying plate 4 and the mounting plate 3. The method may further comprise monitoring the resonance characteristics of the pump 2 or pump assembly during operation and using the output of the monitoring to adjust settings of the device 1 when necessary to ensure that vibrational requirements are fulfilled. In that case, the device 1 may be provided with sensors (not shown) on the device 1 itself or to be placed on the pump 2 or pump assembly.

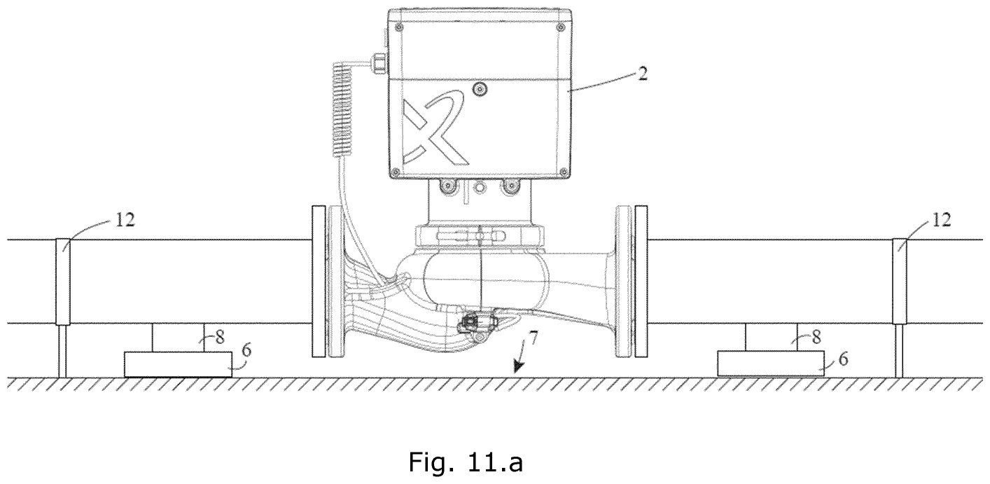

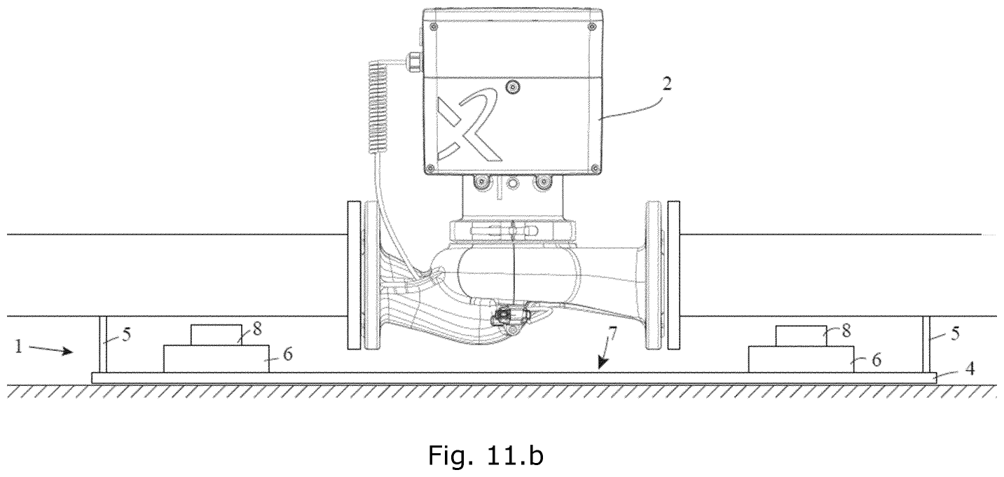

FIG. 11 schematically shows two embodiments in which the device does not comprise a mounting plate. In the embodiment in FIG. 11.a, pipe carriers 12 are arranged on both sides of the pump 2 for carrying it; such pipe carriers are known on their own. The illustrated device for controlling the operational vibrations of the pump 2 or pump assembly is in the form of two linear actuators 6 which are configured to switch between a first state and a second state in the same way as described above. FIG. 11.a shows the first state in which the actuator pistons 8 of the actuators 6 provide a physical connection between the pipes with which the pump 2 is connected and a carrying surface 7, which in this example is the floor. Thus, in this example, the pump assembly comprises the pump and at least a part of the pipes. In the embodiment in FIG. 11.b, the device 1 comprises supports 5 which are configured to carry the weight of the pump assembly so that the pipe carriers 12 in FIG. 11.a can be omitted. Other pipe carriers may still be arranged further away from the pump 2. FIG. 11.b shows the actuators 6 in the second state, in which there is no connection between the pump assembly and the associated carrying surface 7. In this embodiment, the device 1 comprises a carrying plate 4 as also described in relation to the embodiment in the above figures; i.e. the carrying surface 7 is the upper surface of the carrying plate 4. Thus, the device 1 in FIG. 11.b resembles the one in FIG. 2 except that it does not comprise a mounting plate 3. The embodiments in FIG. 11 are shown as comprising actuators 6 in the form of linear actuators. However, other types of actuators as described above may also be used provided that they are configured for suitable cooperation with the pipes.

In the embodiments in FIGS. 11.a and 11,b, the pipe carriers 12 and supports 5 are shown as being arranged symmetrically on both sides of the pump. However, the scope of protection also covers arrangements with one or more pipe carriers and/or supports placed on one side of the pump or on both sides but non-symmetrically with respect to the pump. Furthermore, pipe-carriers and/or supports may be placed far downstream or upstream of the pump compared to what is shown in these figures.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Furthermore, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A device for controlling operational vibrations of a pump or pump assembly arranged thereon, the device comprising:
at least one actuator configured to switch between:
a first state in which the actuator provides a connection between the pump or pump assembly and an associated carrying surface, and
a second state in which there is no connection between the pump or pump assembly and the associated carrying surface via the at least one actuator,
wherein activation of the at least one actuator to switch between the first and the second states is controllable so that resonance characteristics of the pump or pump assembly during operation can be changed by the activation.

2. The device according to claim 1, further comprising at least one support configured to be arranged between the pump or pump assembly and the carrying surface to provide a distance there between, the at least one support being configured to carry the weight of the pump or pump assembly.

3. A device for controlling operational vibrations of a pump or pump assembly arranged thereon, the device comprising:
a mounting plate configured to have the pump or pump assembly arranged on a surface thereof,
at least one support arranged between the mounting plate and a carrying surface to provide a distance there between, the at least one support being configured to carry the weight of the mounting plate and the pump or pump assembly,
at least one actuator configured to switch between:
a first state in which the actuator provides a connection between the mounting plate and the carrying surface, and
a second state in which there is no connection between the mounting plate and the carrying surface via the at least one actuator,
wherein activation of the at least one actuator to switch between the first and the second states is controllable so that resonance characteristics of the pump or pump assembly during operation can be changed by the activation.

4. The device according to claim 1, wherein the connection between the pump or pump assembly and the carrying surface when the at least one actuator is in the first state is a physical connection.

5. The device according to claim 1, wherein the location of the at least one actuator with respect to the pump or pump assembly is adjustable.

6. (canceled)

7. The device according to claim 1, wherein the at least one actuator is a self-locking actuator.

8. The device according to claim 1, wherein the at least one actuator is at least one electromagnet.

9. (canceled)

10. (canceled)

11. The device according to claim 2, wherein the at least one support is adjustable to change the distance between the pump or pump assembly and the carrying surface.

12. The device according to claim 1, wherein the device comprises a plurality of individually controllable actuators.

13. The device according to claim 1, wherein the device is configured to monitor the resonance characteristics of the pump or pump assembly during operation and to use the output of the monitoring to automatically adjust settings of the device when necessary to ensure that vibrational requirements are fulfilled.

14. A method of controlling operational vibrations of a pump or pump assembly, the method comprising the following steps:
arranging a device according to claim 1 at a location of installation of the pump or pump assembly,
setting the device to control the operational vibrations of the pump or pump assembly while taking into account resonance characteristics of the pump or pump assembly, and
operating the pump or pump assembly.

15. (canceled)

16. (canceled)

17. The method according to claim 14, further comprising monitoring the resonance characteristics of the pump or pump assembly during operation and using the output of the monitoring to adjust settings of the device when necessary to ensure that vibrational requirements are fulfilled.

18. The device according to claim 3, wherein the connection between the mounting plate and the carrying surface when the at least one actuator is in the first state is a physical connection.

19. The device according to claim 3, wherein the location of the at least one actuator with respect to a plane of extension of the mounting plate is adjustable.

20. The device according to claim 3, wherein the at least one support is adjustable to change the distance between the mounting plate and the carrying surface.

21. The device according to claim 3, wherein the at least one actuator is a self-locking actuator.

22. The device according to claim 3, wherein the at least one actuator is at least one electromagnet.

23. The device according to claim 3, wherein the device comprises a plurality of individually controllable actuators.

24. The device according to claim 3, wherein the device is configured to monitor the resonance characteristics of the pump or pump assembly during operation and to use the output of the monitoring to automatically adjust settings of the device when necessary to ensure that vibrational requirements are fulfilled.

25. A method of controlling operational vibrations of a pump or pump assembly, the method comprising the following steps:
arranging a device according to claim 3 at a location of installation of the pump or pump assembly,
setting the device to control the operational vibrations of the pump or pump assembly while taking into account resonance characteristics of the pump or pump assembly, and
operating the pump or pump assembly.

26. The method according to claim 25, further comprising monitoring the resonance characteristics of the pump or pump assembly during operation and using the output of the monitoring to adjust settings of the device when necessary to ensure that vibrational requirements are fulfilled.
